(19) United States
(12) Patent Application Publication
(10) Pub. No.: US 2019/0242181 A1
(43) Pub. Date: Aug. 8, 2019

(54) Pest Barrier Assembly

(71) Applicant: Joan Clark, Randallstown, MD (US)

(72) Inventor: Joan Clark, Randallstown, MD (US)

(21) Appl. No.: 15/891,478

(22) Filed: Feb. 8, 2018

(51) Int. Cl. E06B 7/28; E06B 1/62

(52) U.S. Cl. CPC E06B 7/28; E06B 3/30; E06B 1/62

(57) ABSTRACT

A pest barrier assembly for preventing a pest from passing beneath a door includes a shell that defines an interior space. The shell is flexible. The shell is configured to couple to a bottom of a door so that the shell extends between opposing edges of the door. A filler is positioned in and substantially occupies the interior space. The shell is configured to close a gap between the bottom of the door and a surface below the door when the door is closed. The filler is metallic so that the filler is configured to deter chewing of the shell by a pest. The pest is deterred from passing beneath the door.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to barrier assemblies and more particularly pertains to a new barrier assembly for preventing a pest from passing beneath a door.

### BRIEF SUMMARY OF THE INVENTION

An embodiment of the disclosure meets the needs presented above by generally comprising a shell that defines an interior space. The shell is flexible. The shell is configured to couple to a bottom of a door so that the shell extends between opposing edges of the door. A filler is positioned in and substantially occupies the interior space. The shell is configured to close a gap between the bottom of the door and a surface below the door when the door is closed. The filler is metallic so that the filler is configured to deter chewing of the shell by a pest. The pest is deterred from passing beneath the door.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top view of a pest barrier assembly according to an embodiment of the disclosure.

FIG. 2 is a bottom view of an embodiment of the disclosure.

FIG. 3 is an isometric perspective view of an embodiment of the disclosure.

FIG. 4 is a cross-sectional view of an embodiment of the disclosure.

FIG. 5 is an in-use view of an embodiment of the disclosure.

### DETAILED DESCRIPTION OF THE INVENTION

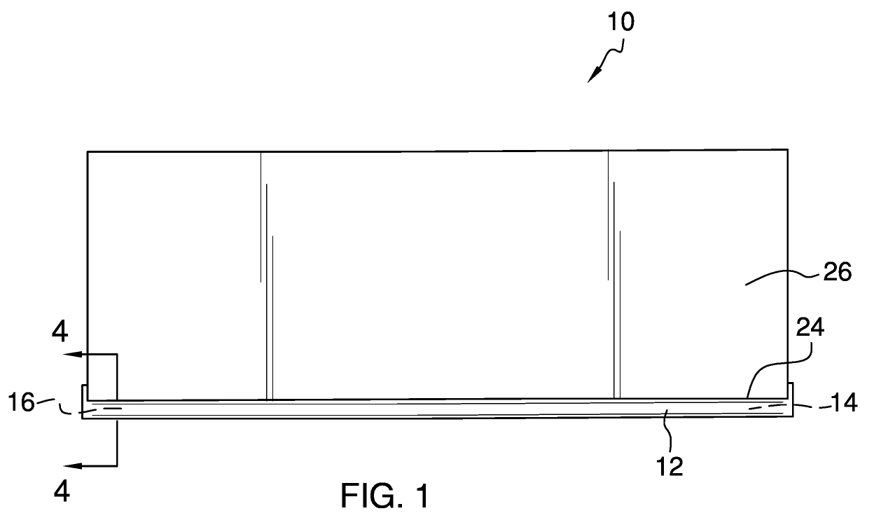

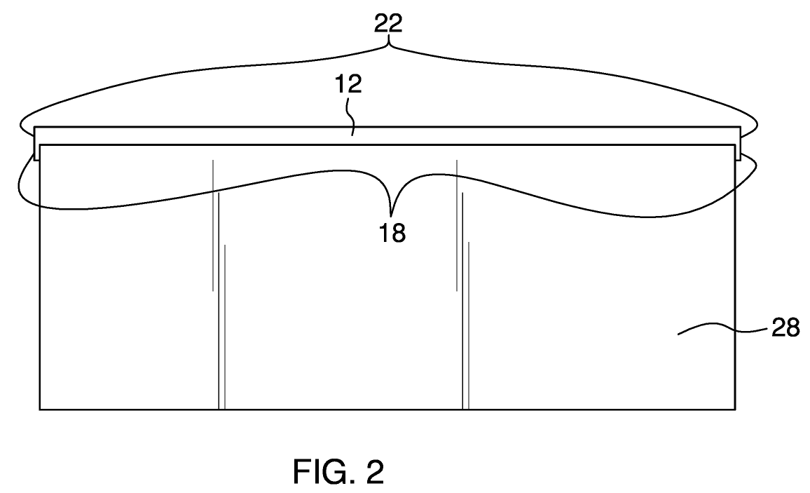

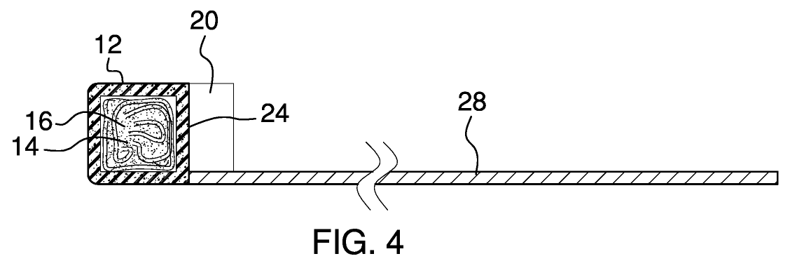

With reference now to the drawings, and in particular to FIGS. 1 through 5 thereof, a new barrier assembly embodying the principles and concepts of an embodiment of the disclosure and generally designated by the reference numeral 10 will be described.

As best illustrated in FIGS. 1 through 5, the pest barrier assembly 10 generally comprises a shell 12 that defines an interior space 14. The shell 12 is flexible. The shell 12 is configured to couple to a bottom of a door so that the shell 12 extends between opposing edges of the door.

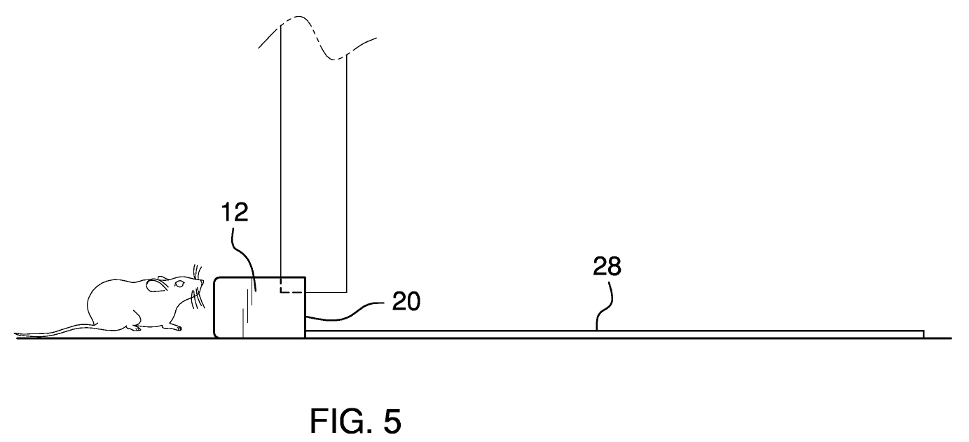

A filler 16 is positioned in and substantially occupies the interior space 14. The shell 12 is configured to close a gap between the bottom of the door and a surface below the door when the door is closed, as shown in FIG. 5. The surface below the door may be a floor of a structure, a sill, a threshold, or the like. The filler 16 is metallic so that the filler 16 is configured to deter chewing of the shell 12 by a pest, such as a rodent. The pest is deterred from passing beneath the door. The filler 16 comprises steel wool or the like.

A pair of couplers 18 is coupled singly to opposing ends 22 of the shell 12. The couplers 18 are configured to couple to the door. Each coupler 18 is configured to couple to the door proximate to a respective opposing edge of the door to couple the shell 12 to the door and to position the shell 12 to close the gap between the bottom of the door and the surface below the door when the door is closed.

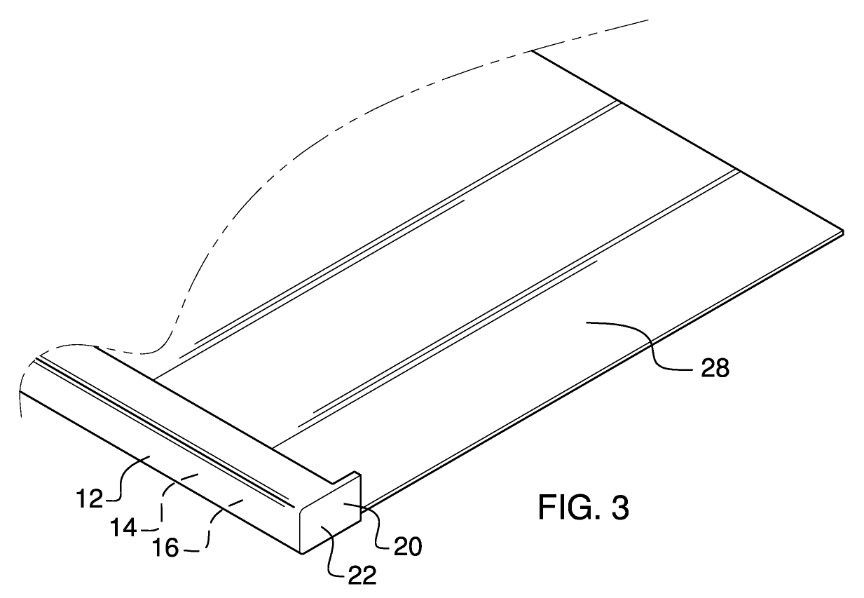

Each coupler 18 comprises a plate 20 that is coupled to and extends from a respective opposing end 22 of the shell 12 past a back 24 of the shell 12, as shown in FIG. 3. Each plate 20 is configured to frictionally couple to the respective opposing edge of the door to couple the shell 12 to the door and to position the shell 12 to close the gap between the bottom of the door and the surface below the door when the door is closed. The plates 20 are rectangularly shaped when viewed from the respective opposing end 22 of the shell 12.

A handle 26 is coupled to and extends from the back 24 of the shell 12. The handle 26 extends under the door when the shell 12 is coupled to the door. The shell 12 is positioned on a first side of the door and the handle 26 is accessible from a second side of the door. The handle 26 is configured to be grasped in a hand of a user to position the shell 12 adjacent to the first side of the door to close the gap between the bottom of the door and the surface below the door when the door is closed.

The handle 26 comprises a panel 28. The panel 28 is rigid. The panel 28 is rectangularly shaped. The panel 28 extends between the opposing ends 22 of the shell 12. The panel 28 is coupled to the plates 20. The panel 28 comprises metal. The panel 28 comprises aluminum or the like.

In use, the handle 26 is configured to be grasped in a hand of a user to position the shell 12 adjacent to the first side of the door to close the gap between the bottom of the door and the surface below the door when the door is closed. The pest is deterred from passing beneath the door.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A pest barrier assembly comprising:
a shell defining an interior space, said shell being configured for coupling to a bottom of a door such that said shell extends between opposing edges of the door;
a filler positioned in and substantially occupying said interior space such that said shell is configured for closing a gap between the bottom of the door and a surface below the door when the door is closed, said filler being metallic such that said filler is configured for deterring chewing of said shell by a pest such that the pest is deterred from passing beneath the door; and
a pair of couplers coupled singly to opposing ends of said shell, said couplers being configured for coupling to the door, wherein said couplers are positioned on said shell such that each said coupler is configured for coupling to said door proximate to a respective opposing edge of the door for coupling said shell to the door and positioning said shell for closing the gap between the bottom of the door and the surface below the door when the door is closed, each said coupler comprising a plate coupled to and extending from a respective opposing end of said shell past a back of said shell such that said plates are oppositely positioned across said shell, wherein said plates are positioned on said shell such that each said plate is configured for frictionally coupling to the respective opposing edge of the door for coupling said shell to the door and positioning said shell for closing the gap between the bottom of the door and the surface below the door when the door is closed.

2. The assembly of claim 1, further including said filler comprising steel wool.

3. (canceled)

4. (canceled)

5. The assembly of claim 1, further including said plates being rectangularly shaped when viewed from said respective opposing end of said shell.

6. The assembly of claim 1, further including a handle coupled to and extending from said back of said shell such that said handle extends under the door when said shell is coupled to the door such that said shell is positioned on a first side of the door and said handle is accessible from a second side of the door for grasping said handle in a hand of a user for positioning said shell adjacent to the first side of the door for closing the gap between the bottom of the door and the surface below the door when the door is closed.

7. The assembly of claim 1, further including a panel coupled to and extending from said back of said shell such that said panel extends under the door when said shell is coupled to the door such that said shell is positioned on a first side of the door and said panel is accessible from a second side of the door for grasping said panel in a hand of a user for positioning said shell adjacent to the first side of the door for closing the gap between the bottom of the door and the surface below the door when the door is closed.

8. (canceled)

9. The assembly of claim 7, further including said panel being rectangularly shaped.

10. The assembly of claim 7, further including said panel extending between said opposing ends of said shell.

11. The assembly of claim 10, further including said panel being coupled to said plates.

12. The assembly of claim 7, further including said panel comprising metal.

13. The assembly of claim 12, further including said panel comprising aluminum.

14. A pest barrier assembly comprising:
a shell defining an interior space, said shell being configured for coupling to a bottom of a door such that said shell extends between opposing edges of the door;
a filler positioned in and substantially occupying said interior space such that said shell is configured for closing a gap between the bottom of the door and a surface below the door when the door is closed, said filler being metallic such that said filler is configured for deterring chewing of said shell by a pest such that the pest is deterred from passing beneath the door, said filler comprising steel wool;
a pair of couplers coupled singly to opposing ends of said shell, said couplers being configured for coupling to the door, wherein said couplers are positioned on said shell such that each said coupler is configured for coupling to said door proximate to a respective opposing edge of the door for coupling said shell to the door and positioning said shell for closing the gap between the bottom of the door and the surface below the door when the door is closed, each said coupler comprising a plate coupled to and extending from a respective opposing end of said shell past a back of said shell such that said plates are oppositely positioned across said shell, wherein said plates are positioned on said shell such that each said plate is configured for frictionally coupling to the respective opposing edge of the door for coupling said shell to the door and positioning said shell for closing the gap between the bottom of the door and the surface below the door when the door is closed, said plates being rectangularly shaped when viewed from said respective opposing end of said shell;
a handle coupled to and extending from said back of said shell such that said handle extends under the door when said shell is coupled to the door such that said shell is positioned on a first side of the door and said handle is accessible from a second side of the door for grasping said handle in a hand of a user for positioning said shell adjacent to the first side of the door for closing the gap between the bottom of the door and the surface below the door when the door is closed, said handle comprising a panel, said panel being rectangularly shaped, said panel extending between said opposing ends of said shell, said panel being coupled to said plates, said panel comprising metal, said panel comprising aluminum; and
wherein said handle is configured for grasping in the hand of the user for positioning said shell adjacent to the first side of the door for closing the gap between the bottom of the door and the surface below the door when the door is closed such that the pest is deterred from passing beneath the door.
